(19) United States
(12) Patent Application Publication
(10) Pub. No.: US 2018/0137434 A1
(43) Pub. Date: May 17, 2018

(54) CHARACTER STRING RECOGNITION METHOD AND MACHINE LEARNING METHOD

(71) Applicants: INVENTEC (PUDONG) TECHNOLOGY CORPORATION, Shanghai City (CN); INVENTEC CORPORATION, Taipei City (TW)

(72) Inventors: Chung-Chiang CHEN, Taipei City (TW); Jia-Yu JUANG, Taipei City (TW); Shao-Liang PENG, Taipei City (TW); Te-Yi WU, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 15/479,135

(22) Filed: Apr. 4, 2017

(30) Foreign Application Priority Data
Nov. 14, 2016 (CN) 201610998341.1

(51) Int. Cl. G06N 99/00; G06F 17/30; G06F 17/27

(52) U.S. Cl. CPC G06N 99/005; G06F 17/2765; G06F 17/30657

(57) ABSTRACT

A character string recognition method includes: selecting a keyword database, which corresponds to content of a character string, from a number of keyword databases, wherein the selected keyword database comprises at least one prefix keyword, comparing the content of the character string with the at least one prefix keyword, when the content of the character string corresponds to one of the at least one prefix keyword, updating the content of the character string based on a definition of the prefix keyword which corresponds to the content of the character string, and when the content of the character string does not correspond to any of the at least one prefix keyword, selectively ending the character string recognition method, and outputting the content of the character string.

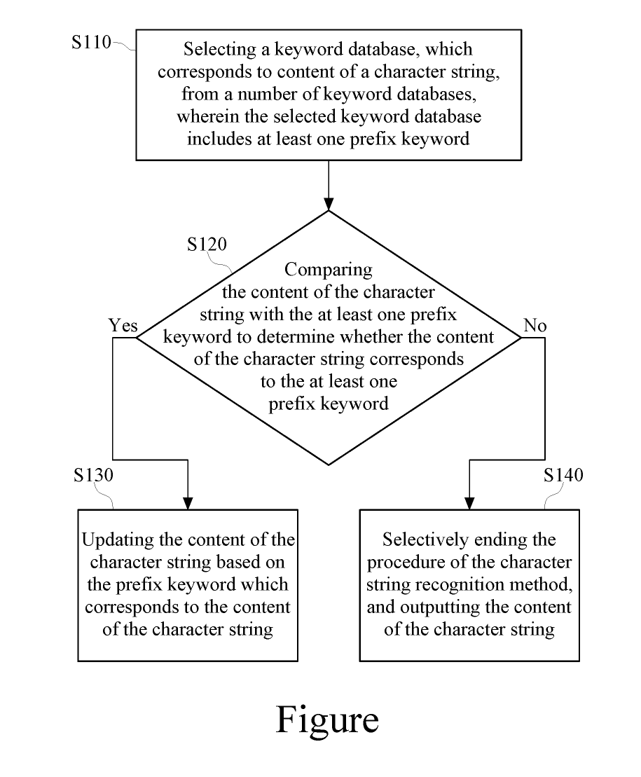

### CROSS-REFERENCE TO RELATED APPLICATION

This non-provisional application claims priority under 35 U.S.C. § 119(a) to Patent Application No. 201610998341.1 filed in China on Nov. 24, 2016, the entire contents of which are hereby incorporated by reference.

### BACKGROUND

### Technical Field

This disclosure relates to a character string recognition method and a machine learning method, and particularly to a character string recognition method and a machine learning method of decreasing the dispersion level of data.

### Related Art

Artificial intelligence technology such as deep learning and artificial neural network has been developed rapidly in recent years. Another important technique in the field of artificial intelligence is machine learning. One of the machine learning methods is to provide the computers a large amount of documents and consequently make the computers construct a certain interpreting principle and other corresponding artificial intelligence operating principles.

However, in some fields, the documents may carry a great amount of abbreviations and codes. People can indicate the same thing with various codes and abbreviations respectively. Therefore, how to improve the capability of a computer to interpret codes and abbreviations is what waits to be conquered.

### SUMMARY

According to one or more embodiments of this disclosure, the character string recognition method includes: selecting a keyword database, which corresponds to content of a character string, from a number of keyword databases, wherein the selected keyword database comprises at least one prefix keyword; comparing the content of the character string with the at least one prefix keyword; when the content of the character string corresponds to one of the at least one prefix keyword, updating the content of the character string based on a definition of the prefix keyword which corresponds to the content of the character string; and when the content of the character string does not correspond to the at least one prefix keyword, selectively ending the character string recognition method, and outputting the content of the character string.

According to one or more embodiments of this disclosure, the machine learning method includes executing machine learning according to the updated content of the character string after the aforementioned character string recognition method.

### BRIEF DESCRIPTION OF THE DRAWING

The present disclosure will become more fully understood from the detailed description given hereinbelow and the accompanying drawing which is given by way of illustration only and thus is not limitative of the present disclosure and wherein:

The FIGURE is a flowchart according to a character string recognition method in an embodiment of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of this disclosure, as shown in the FIGURE, the character string recognition method includes the following steps, wherein the following steps can be performed by a computer including a processor and a storage medium. In step S110, a keyword database, which corresponds to content of a character string, is selected from a number of keyword databases, wherein the keyword database includes at least one prefix keyword. In step S120, the content of the character string is compared with the at least one prefix keyword. In step S130, when the content of the character string corresponds to one of the at least one prefix keyword, the content of the character string is updated based on a definition of the prefix keyword which corresponds to the content of the character string. In step S140, when the content of the character string does not correspond to any of the at least one prefix keyword, a procedure of the character string recognition method is selectively ended, and the content of the character string is output.

In an embodiment, step S110 includes searching for a prefix keyword which corresponds to one or more initial characters of the character string, from the keyword databases, in order to confirm the keyword database corresponding to the content of the character string. For example, when the received character string is “WIN2008_xxx R2 x64”, the character string is determined as indicating “Windows” based on its initial characters “WIN”, so that the keyword database related to the products of Microsoft may be selected.

However, when the received character string is “W2008 R2 x64” but no keyword “W” exists in the keyword databases, the etymon keyword “2008” and/or the suffix keyword “R2” is used for searching for a keyword database which includes the etymon keyword and/or the suffix keyword. Thereby, the keyword database related to the products of Microsoft can be found. In addition, because the etymon keyword “2008” and the suffix keyword “R2” correspond to a prefix keyword, which is related to “Windows”, the computer is able to determine that “W” may indicate “Windows”. Therefore, the computer adds “W” as a new prefix keyword with a definition “Windows” in the keyword database, which is related to the products of Microsoft. The definition rule related to the keyword database is shown as Table 1.

TABLE 1

| Keyword | Definition |
|---|---|
| W | WINDOWS |
| WIN | |
| WINDOW | |
| 2008 | 2008 |
| 08 | |
| SP | Service pack |
| R | Release, Service pack |

In an embodiment, each prefix keyword in the keyword database has at least one corresponding etymon keyword. As the aforementioned example of “Windows”, the at least one etymon keyword is, for example, 95, 98, ME, 2000, XP, 2008, Vista, 7, 8, 10, etc. In step S130, the content of the character string is compared with the aforementioned etymon keyword. When the content of the character string corresponds to one of the at least one etymon keyword, the content of the character string is updated based on the definition of the etymon keyword which corresponds to the content of the character string. As the aforementioned example, “2008 xxx” is determined as corresponding to the etymon keyword “2008”, so that the content of the character string is updated correspondingly. When the content of the character string does not correspond to any of the at least one etymon keyword, the procedure is selectively ended and the content of the character string is output. For example, in the keyword database related to the products of Microsoft, an etymon keyword corresponding to a character string “W2007” cannot be found from the etymon keywords corresponding to “Windows” (the definition of the prefix keyword), so that the procedure of searching for the etymon keyword corresponding to a character string “W2007” from the etymon keywords corresponding to “Windows” can be ended. At this time, the computer is able to re-determine that the prefix keyword “W” corresponding to the character “W” indicates the definition of “Word”, so that the computer updates “W2007” to be “Word2007” and then executes the procedure for further searching and updating the character string. In the techniques for processing natural language, the technique of searching for an etymon keyword, prefix keyword and/or suffix keyword is fully developed, so the related details are not described herein.

In an embodiment, each prefix keyword in the keyword database has one or more corresponding suffix keywords. As the aforementioned example of “Windows”, the one or more suffix keywords are, for example, x32, x64, R2, and/or other related keyword. In step S130, the content of the character string is compared with the suffix keywords. When the content of the character string corresponds to one of the suffix keywords, the content of the character string is updated based on the definition of the suffix keyword. When the content of the character string does not correspond to any of the etymon keywords, the procedure is ended, and the content of the character string is output. The procedure is similar to the processing of the etymon keyword, so it is not described herein. In an embodiment, during searching for a possible suffix keyword in the character string, the method is starting from the character corresponding to the prefix keyword to determine whether each character corresponds to one of the at least one suffix keyword by the comparison between each character and the at least one suffix keyword. For example, when the character string “W2008 R2 x64” is orderly examined after “W” is determined as the prefix keyword, “2008” is not determined as a suffix keyword and then “R2” is determined as a suffix keyword.

Therefore, in the aforementioned character string recognition method, each prefix keyword in the keyword database corresponds to one or more etymon keywords and/or one or more suffix keywords; vice versa. Accordingly, in an embodiment, the definition of each prefix keyword includes the definition of the corresponding etymon keyword and/or the definition of the corresponding suffix keyword besides the definition of itself. Similarly, the definition of each etymon keyword includes the definition of the corresponding prefix keyword and/or the definition of the corresponding suffix keyword besides the definition of itself. Thus, the keywords are associated with each other so the efficiency of searching for and updating keywords may be increased.

More concretely, when the computer collects 100 pieces of reference data of a field, an operator or a computer selects, for example, 20 pieces from the 100 pieces of reference data in advance, and then uses the keywords of these 20 pieces of reference data to build a keyword database in which a number of prefix keywords, a number of etymon keywords and/or a number of suffix keywords are defined. Afterwards, when the computer reads the other 80 pieces of reference data or other later reference data, the computer is able to execute the method exemplified by the aforementioned embodiments. In this way, the content of the reference data may be more uniformized. Therefore, it may become easier for the computer to execute the machine learning. Moreover, when related reference data is added, the keyword database can be expanded by the aforementioned method, so that the method provided in this disclosure is more executable.

Moreover, in an embodiment, a machine learning method for data acquisition includes the character string recognition method in any aforementioned embodiment. When the computer receives the updated content of the character string, the computer executes machine learning according to the updated content of the character string.

In addition, in another embodiment of this disclosure, the computer further includes a database in the storage medium; thereby, the computer is able to establish a using rule of each user based on the database. For example, a user habitually uses “W2003” to indicate “Word2003”, and uses“window2000” to indicate “Windows2000”, so that the computer generalizes a keyword usage habit of the user and stores the data of the keyword usage habit in the storage medium. Therefore, when the user addresses a request to the computer, the computer displays “window 10” to the user in order to recommend the user “Windows 10”. Therefore, such an operational service may more fit in or satisfy the usage habit of the user.

Because the character strings are updated to be in a uniform form, the dispersion level of the character strings is decreased for the computer learning, so that the machine learning may be easier.

What is claimed is:

1. A character string recognition method, comprising:
selecting a keyword database, which corresponds to content of a character string, from a plurality of keyword databases, wherein the selected keyword database comprises at least one prefix keyword;
comparing the content of the character string with the at least one prefix keyword;
when the content of the character string corresponds to one of the at least one prefix keyword, updating the content of the character string based on a definition of the prefix keyword which corresponds to the content of the character string; and
when the content of the character string does not correspond to the at least one prefix keyword, selectively ending the character string recognition method, and outputting the content of the character string.

2. The character string recognition method according to claim 1, wherein in the selected keyword database, each of the at least one prefix keyword corresponds to at least one suffix keyword, and the updating the content of the character string based on the definition of the prefix keyword which corresponds to the content of the character string comprises:
comparing the content of the character string with the at least one suffix keyword;
when the content of the character string corresponds to one of the at least one suffix keyword, updating the content of the character string based on a definition of the suffix keyword which corresponds to the content of the character string; and
when the content of the character string does not correspond to any of the at least one suffix keyword, selectively ending the character string recognition method, and outputting the content of the character string.

3. The character string recognition method according to claim 2, wherein the comparing the content of the character string with the at least one suffix keyword comprises: starting from a character of the content of the character string, which corresponds to the prefix keyword, to determine whether each character of the character string corresponds to the at least one suffix keyword by comparison between each character of the character string and the at least one suffix keyword.

4. The character string recognition method according to claim 1, wherein in the selected keyword database, each of the at least one prefix keyword corresponds to at least one etymon keyword, and the updating the content of the character string based on the definition of the prefix keyword which corresponds to the content of the character string comprises:
comparing the content of the character string with the at least one etymon keyword;
when the content of the character string corresponds to one of the at least one etymon keyword, updating the content of the character string based on a definition of the etymon keyword which corresponds to the content of the character string; and
when the content of the character string does not correspond to any of the at least one etymon keyword, selectively ending the character string recognition method, and outputting the content of the character string.

5. The character string recognition method according to claim 1, wherein the selecting the keyword database, which corresponds to the content of the character string, from the plurality of keyword databases comprises: searching a prefix keyword which corresponds to the content of the character string, based on one or more initial characters of the character string, from the plurality of keyword databases, in order to confirm the keyword database corresponding to the content of the character string.

6. The character string recognition method according to claim 5, wherein the selecting the keyword database corresponding to the content of the character string from the plurality of keyword databases further comprises:
when no prefix keyword which corresponds to the content of the character string exists in the plurality of keyword databases, searching for a suffix keyword or an etymon keyword, which corresponds to one or more characters of the content of the character string, in the plurality of keyword databases; and
based on the one or more characters and the suffix keyword or the etymon keyword, which corresponds to the one or more characters, selectively determining that at least one character previous to the one or more characters is a definition of a prefix keyword which corresponds to the suffix keyword or the etymon keyword corresponding to the one or more characters.

7. The character string recognition method according to claim 6, wherein a new prefix keyword is obtained by directing the at least one character to the definition of the prefix keyword which corresponds to the suffix keyword or the etymon keyword.

8. A machine learning method for data acquisition, comprising:
the character string recognition method according to claim 1; and
executing machine learning, according to the updated content of the character string, by a computer.

9. A machine learning method for data acquisition, comprising:
the character string recognition method according to claim 2; and
executing machine learning, according to the updated content of the character string, by a computer.

10. A machine learning method for data acquisition, comprising:
the character string recognition method according to claim 3; and
executing machine learning, according to the updated content of the character string, by a computer.

11. A machine learning method for data acquisition, comprising:
the character string recognition method according to claim 4; and
executing machine learning, according to the updated content of the character string, by a computer.

12. A machine learning method for data acquisition, comprising:
the character string recognition method according to claim 5; and
executing machine learning, according to the updated content of the character string, by a computer.

13. A machine learning method for data acquisition, comprising:
the character string recognition method according to claim 6; and
executing machine learning, according to the updated content of the character string, by a computer.

14. A machine learning method for data acquisition, comprising:
the character string recognition method according to claim 7; and
executing machine learning, according to the updated content of the character string, by a computer.
